(19) United States
(12) Patent Application Publication
(10) Pub. No.: US 2013/0260443 A1
(43) Pub. Date: Oct. 3, 2013

(54) ODOR FILTER

(71) Applicant: MTarri/Varani Emissions Treatment, LLC d/b/a MV Technologies, (US)

(72) Inventors: Frederick T. Varani, Denver, CO (US); Paul Bertram Trost, Golden, CO (US); Todd Michael Niswender, Loveland, CO (US); Aaron Primmer, Golden, CO (US)

(73) Assignee: MTarri/Varani Emissions Treatment, LLC d/b/a MV Technologies, Golden, CO (US)

(21) Appl. No.: 13/799,348

(22) Filed: Mar. 13, 2013

Related U.S. Application Data
(60) Provisional application No. 61/686,052, filed on Mar. 30, 2012.
(60) Provisional application No. 61/686,053, filed on Mar. 30, 2012.
(60) Provisional application No. 61/688,250, filed on May 11, 2012.

(51) Int. Cl. B01D 53/48

(52) U.S. Cl. CPC B01D 53/48
USPC 435/266; 29/428; 422/168; 422/4; 435/289.1

(57) ABSTRACT

A portable odorous gas filter may provide for substantially even distribution of byproduct gas throughout a containment vessel by utilizing a diffuser plate having a plurality of holes therein. Byproduct gas from manufacturing or treatment processes may be directed into a gas plenum layer in the containment vessel through an inlet below the diffuser plate. The geometry of the diffuser plate may provide for a high-pressure differential between the plenum layer below the plate and a filter layer containing an odor-filtering media above the plate. Certain types bacteria and/or fungal strains may be added to extend the effective life of the biological media used therein.

### CROSS-REFERENCE TO RELATED APPLICATIONS

The present application claims benefit of priority to the following U.S. Provisional Patent Applications: Patent Application No. 61/686,052, entitled “Beneficial Usage of Acidophile Bacteria” and filed on Mar. 30, 2012; Patent Application No. 61/686,053, entitled “Simultaneous Removal of Gaseous Sulfide Compounds (H2S) and Siloxanes by Biologically enhanced Iron Sponge” and filed on Mar. 30, 2012; and Patent Application No. 61/688,250, entitled “Utilization of Strong Oxidizing Agents to Extend the Operating Life of Iron Oxide Based on H2S Removal Systems without the Addition of Air” and filed on May 11, 2012. These three provisional applications are specifically incorporated by reference herein for all that they disclose or teach.

### BACKGROUND

Existing methods of hydrogen sulfide and odorous gas treatment typically employ large, concrete, pre-cast vessels with river rock to support iron sponge media. These vessels are prone to cracking and assembled vessels typically exceed commercial weight limits. The non-portable nature of these vessels increases associated labor and maintenance costs.

### SUMMARY

Implementations of the system described herein provide for a odorous gas filter containment vessel and system that ensures even distribution of byproduct gas throughout a containment vessel by utilizing a diffuser plate having a plurality of holes that systematically create an engineered pressure drop across the plate. Byproduct gas from manufacturing or treatment processes is directed into a gas plenum layer in the containment vessel through a gas inlet below the diffuser plate. The geometry of the diffuser plate creates a pressure differential between the plenum layer below the plate and a filter layer above the plate, causing the byproduct gas to evenly distribute throughout the plenum layer before crossing the diffuser plate and entering the filter layer. In the filter layer, the byproduct gas reacts with media including iron hydroxide and select odorous components are effectively filtered from the byproduct gas. In one implementation, the filter containment vessel is portable.

This Summary is provided to introduce an election of concepts in a simplified form that are further described below in the Detailed Description. This Summary is not intended to identify key features or essential features of the claimed subject matter, nor is it intended to be used to limit the scope of the claimed subject matter. Other features, details, utilities, and advantages of the claimed subject matter will be apparent from the following more particular written Detailed Description of various implementations and implementations as further illustrated in the accompanying drawings and defined in the appended claims.

### BRIEF DESCRIPTIONS OF THE DRAWINGS

A further understanding of the nature and advantages of the present technology may be realized by reference to the figures, which are described in the remaining portion of the specification.

FIG. 1 illustrates a partial cut-away view of an example odorous gas filter containment system.

FIG. 2 is an isometric view of a diffuser plate assembly in an example odorous gas filter system in one implementation.

FIG. 3 is an example diffuser plate suitable for implementation in an example odorous gas filter system in one implementation.

FIG. 4 illustrates a top perspective view of an example odorous gas filter system in one implementation.

FIG. 5 illustrates a front perspective view of an example odorous gas filter system in one implementation.

FIG. 6 illustrates an isometric perspective view of an example odorous gas filter system in one implementation.

FIG. 7 is a cross-sectional view of an example odorous gas filter system in one implementation.

FIG. 8 illustrates example operations for an odor filter system according to one implementation.

FIG. 9 illustrates example operations for disposing of odor-filtering media in an odor filter system according to one implementation.

### DETAILED DESCRIPTIONS OF THE DRAWINGS

To remove hydrogen sulfide (H₂S) and other odorous, sulfur-bearing, gaseous compounds such as thiols, disulfides, and mercaptans from byproduct gas streams, byproduct gas may be filtered through an iron sponge media containing iron hydroxide. When the byproduct gas is filtered through the iron sponge media, the byproduct gas reacts with one or more odorous compounds, yielding pyrite or a pyrite-type compound that can be collected and moved to a landfill for disposal.

Some existing odor treatment filters employ heavy, concrete containment vessels containing iron sponge media. However, concrete is prone to cracking Additionally, such concrete containment vessels can weigh as much as 15,000-20,000 pounds alone and 55,000 to 60,000 pounds with the iron sponge media stored within. Therefore, such vessels typically exceed commercial weight limits (i.e., 24,000 pounds), and have high associated labor costs because spent iron sponge media within the containment vessels must be manually removed (e.g., shoveled out) at the location of filter system and then transported to a landfill. In some cases, special construction equipment may also be employed to remove the spent iron sponge media.

One challenge in constructing a portable containment vessel for an odor filter system is reducing the total weight of the containment vessel while ensuring even distribution of the byproduct gas throughout the containment vessel before the byproduct gas reacts with the iron sponge or other odor-filtering media in the system.

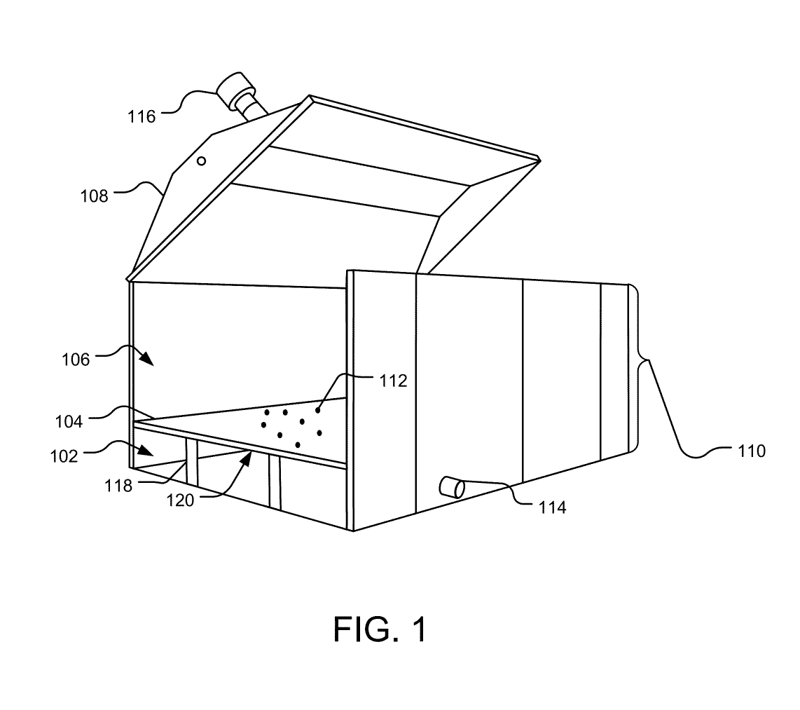

FIG. 1 illustrates a partial cut-away view of an example odorous gas filter containment vessel 100. The containment vessel has a base portion 110 and lid portion 108. In the implementation shown, the base portion 110 is rectangular in shape, having a base and four sidewalls enclosing a space. The space includes a gas plenum layer 102, a supporting diffuser assembly 120, and a filter layer 106. In an alternate implementation, the base portion is cylindrical and thus has a single sidewall enclosing the gas plenum layer 102, supporting diffuser assembly 120, and filter layer 106.

The supporting diffuser assembly 120 (which may also be referred to herein as a diffuser plate assembly) includes a frame structure 118 and one or more diffuser plates 104, having a plurality of holes (e.g., hole 112) that are spaced and sized so as to provide for an engineered pressure drop across the plate 104. In one implementation, the diffuser plate 104 includes multiple panels of rigid plates laid across the frame structure 118.

The gas plenum layer 102 is an enclosed gas cavity that is in fluid communication with the filter layer 106 on the opposite side of the diffuser plate 104. Byproduct gas may be directed into the gas plenum layer 102 through an inlet 114 on a sidewall of the containment vessel 100 located below the diffuser plate 104. As byproduct gas flows into the space below the diffuser plate 104, pressure builds in the plenum layer 102, creating a pressure differential between the gas plenum layer 102 and the filter layer 106. The positioning and geometry of the diffuser plate 104 is such that the byproduct gas is forced to spread out and evenly distribute across the surface area of the diffuser plate 104 before passing through the plurality of holes (e.g., hole 112) and into the filter layer 106.

The filter layer 106 is a cavity that is, in operation, filled with a loosely packed odor-filtering media (which may also be referred to herein as a gas phase chemical filtering media). In one exemplary implementation, the odor-filtering media (not shown) is iron hydroxide impregnated in a wood substrate (also referred to herein as “iron sponge”). In another implementation, the odor-filtering media is iron sponge inoculated with bacteria, such as acidophile bacteria. It should be noted that other materials may be utilized for the filter layer 106 including standard plastic packing, wood chips impregnated with sodium carbonate, zeolites impregnated with iron oxides, clay impregnated with oxides, activated carbon such as activated charcoal, etc.

In operation, byproduct gas passes through an inlet 114 into the gas plenum layer 102, through the diffuser plate 104 and into the filter layer 106, wherein the odorous, sulfur-bearing compounds in the byproduct gas react with the odor-filtering media. The odor-filtering media acts as a “sponge” and removes the odorous gases from the byproduct gas. When the odor-filtering media employed is iron sponge, iron oxide in the iron sponge reacts with hydrogen sulfide in the byproduct gas, creating an iron sulfide compound such as pyrite. The filtered gas exits the containment vessel 100 through one or more vents, such as vent pipe 116, leaving spent odor-filtering media behind in the filter layer 106.

In one implementation, wood chips are used in the odor-filtering media. The wood chips provide for permeability of the byproduct gas through the filter layer 106 and also contain cellulosic chemical compounds that function to physically remove siloxanes and silanols from the byproduct gas. Such removal of gaseous siloxane and silanol compounds occurs due to the interaction of these compounds in the byproduct gas with functional groups (e.g., the functional group —CH₂OH) in repeating glucosic molecules of the wood chips. Removing siloxanes and silanols from byproduct gas can reduce damage and wear to engines, turbines, compressors, and other equipment that may come into contact with the byproduct gas. In another implementation, a chemical containing desired functional groups is added as a liquid or solid to the odor-filtering media and further augmented with other siloxane absorbing materials such as methanol and ethanol.

The containment vessel 100 has one or more openings through which the odor-filtering media within the media layer 106 can be accessed. In one implementation, the containment vessel 100 has a lid portion 108 hingedly attached to a top edge of the containment vessel 100 to provide for loading of the odor-filtering media into the media layer 106. The lid 108 may be made of aluminum or other lightweight material. In the same or a different implementation, the containment vessel has a hinged side door (not shown) that provides for convenient extraction of the odor-filtering media.

The base portion 110 of the containment vessel 100 is formed of a robust and lightweight material such as carbon steel, stainless steel, plastic, polyethylene, polypropylene, fiberglass, etc. In one implementation, the entire containment vessel 100 including the base portion 110 and the lid portion 108 has a weight such that it may be transported on the bed of a truck or otherwise towed from one location to another.

The design illustrated by FIG. 1 is an “upflow” system in that it directs byproduct gas below an odor-filtering media and allows the byproduct gas to rise through the media. “Downflow” systems that pump gas down through odor-filtering media are also contemplated herein; however, one advantage to the upflow design illustrated by FIG. 1 is that certain component cost associated with downflow systems are eliminated. For instance, the lid 108 does not have to be airtight in the upflow system.

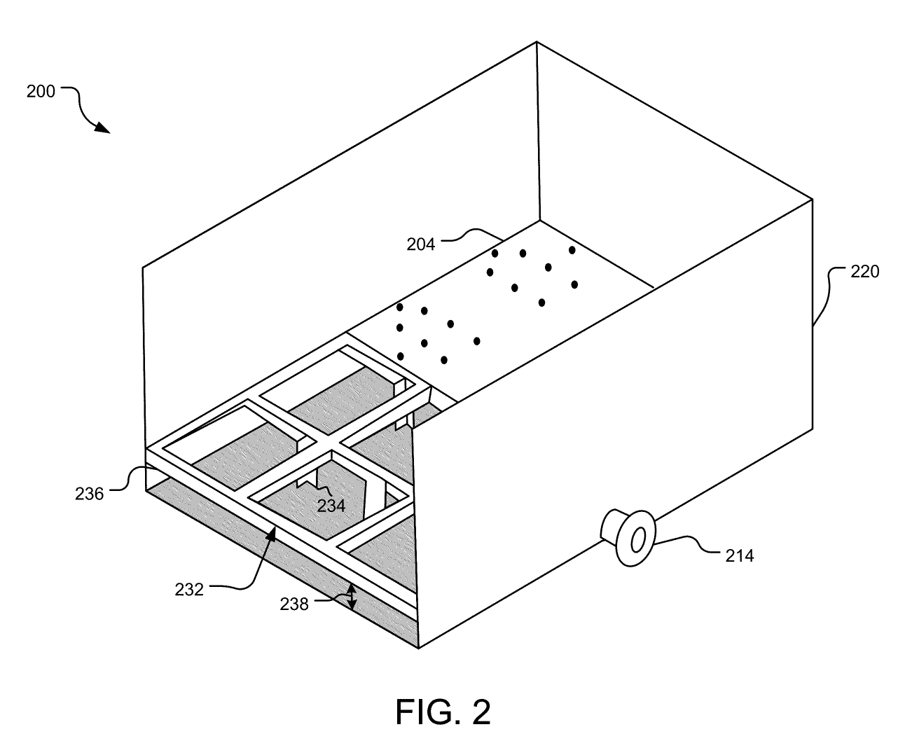

FIG. 2 is an isometric view of a supporting diffuser assembly 200 positioned within an example odorous gas filter system 200 in one implementation. The supporting diffuser assembly 200 includes a frame structure 232 and a diffuser plate 204 having a plurality of holes therein. The frame structure includes multiple support posts 234 and support beams 236 configured to support the diffuser plate 204. In the example implementation illustrated, the diffuser plate 204 includes two diffuser plate panels that sit side-by-side atop the frame structure 232; however, only one of the two diffuser plate panels is illustrated.

The diffuser plate 204 is positioned a distance 238 from the base of a containment vessel 220. The distance 238 is such that the diffuser plate 204 is positioned above a byproduct gas inlet 214 in the containment vessel 220. The distance 238 may depend on specific design criteria such as the diameter of the gas inlet 214 pipe. For example, if the gas inlet 214 pipe has a six-inch diameter, the diffuser plate 204 is to be positioned a distance greater than six-inches from the base of the containment vessel 220.

The supporting diffuser assembly 200 supports the full weight of an odor-filtering media that is to be loaded on top of the diffuser plate 204. Therefore, the diffuser plate 204 is constructed out of a strong, durable material such as aluminum, stainless steel, fiberglass, plastic, etc. The support frame is also made out of a strong, durable material such as carbon steel, stainless steel or aluminum. In one implementation, the diffuser plate 204 is one-quarter inch sheet metal aluminum and includes two 60″×82.75″ panels. In another implementation, the supporting diffuser assembly 200 includes fabric and ribs supporting the fabric. In another implementation, the supporting diffuser assembly 200 includes a geocomposite of a fabric in a net.

The diffuser plate 204 provides for an engineered pressure drop across the diffuser plate 204 in the containment vessel 220. The engineered pressure drop forces the byproduct gas to spread out evenly across the lower surface of the diffuser plate 204 before passing through the plurality of holes in the diffuser plate 204. The evenly distributed byproduct gas then moves up through the layer of odor-filtering media above the diffuser plate 204.

This even distribution of the byproduct gas increases or maximizes that the surface area of the odor-filtering media that contacts the byproduct gas. Consequently, the number of individual reactions that may occur between the odor-filtering media and the byproduct gas is also increased, ensuring a more complete reaction over time of all of the odor-filtering media in the vessel. Accordingly, a smaller amount of the odor-filtering media may suffice to achieve a desired flow rate in this system than in systems that do not utilize a diffuser plate 204 to evenly distribute the byproduct gas.

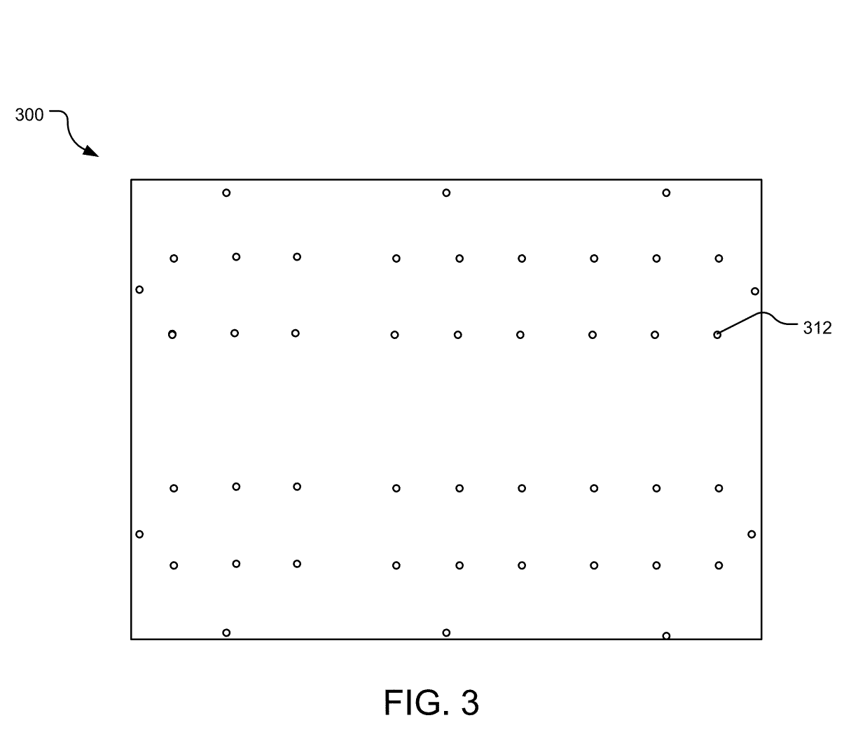

FIG. 3 is an example diffuser plate 300 suitable for implementation in an example odorous gas filter system 200. The diffuser plate 300 has number of holes sized and spaced to achieve a set pressure differential across the diffuser plate 300, when positioned within an odor filter containment vessel that may be the same or similar to that described in FIGS. 1-2, above. In one implementation, the pressure differential created across diffuser plate 300 in the odor containment vessel is a two-inches of water column. In other implementations, this pressure differential may range substantially between 1.8 inches of water column to 5 inches of water column; however, pressure differentials outside of this range are also contemplated.

The holes (e.g., hole 312) in the diffuser plate 300 are 0.5-0.75 inches in diameter; however, the size of the holes may vary depending on the desired flow rate and the size of the system. In alternate implementations, a variety of hole sizes and spacing may be employed to achieve the desired pressure differential across the diffuser plate 300 in the filter system. At least one implementation has variable sized holes and/or variable space size between the holes.

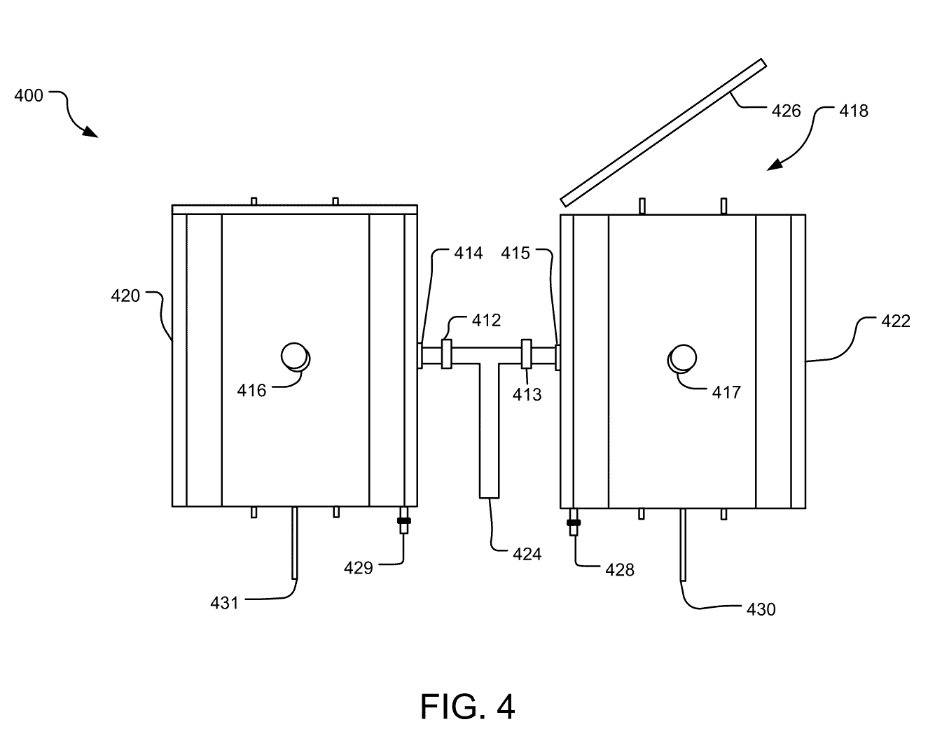

FIG. 4 illustrates a top perspective view of an example odorous gas filter system 400 in one implementation. The system comprises two separate containment vessels (420 and 422) sharing a single byproduct gas inlet 424. In one implementation, the byproduct gas inlet is an eight-inch diameter pipe. Alternate implementations may have multiple byproduct gas inlets, which may be shared between any number of containment vessels. The gas inlet 424 routes the byproduct gas into each of the two containment vessels (420 and 422) through an inlet (e.g., inlets 414 and 415) located near the base of each containment vessel. The containment vessel inlets 414, 415 may have one or more shut-off valves 412, 413 to control the flow of byproduct gas into each respective containment vessel. In one implementation, the shut-off valves 412, 413 are approximately six inches in diameter. The containment vessels 420, 422 also have one or more vents (e.g., vent pipes 416, 417) through which filtered gas exits after passing through an odor-filtering media within the containment vessel 420, 422.

Each of the containment vessels 420 and 422 has a media extraction opening (e.g., opening 418) accessible via a side door 426 attached to at least one sidewall of the containment vessel 420, 422. In the implementation shown, door 426 is hingedly attached to a sidewall of the enclosure 422. In an alternate implementation, the door 426 is removeably attached to the enclosure 422. The media extraction opening 418 facilitates the extraction of heavy, spent odor-filtering media from the containment vessel 420 or 422. For example, in one implementation one or more containment vessels 420, 422 can be loaded onto a truck and transported to a landfill. Once at the landfill, the hinged door 426 on the containment vessel can be opened and the containment vessel can be tipped toward the open door to cause the spent odor-filtering media to fall out or to otherwise facilitate removal. In another implementation, the containment vessels 420, 422 have wheels so that the containment vessels 420, 422 can be pushed, pulled, or towed from one location to another.

In an alternate implementation, a non-stick coating, such as Teflon, is applied to the interior walls of the containment vessel 420, 422 to prevent odor-filtering media from “sticking” to the containment vessel interior. In yet another implementation, the odor-filtering media stored within the containment vessel 420, 422 is contained within a net or geotextile material that can be used to leverage the odor-filtering media out of the containment vessel 420, 422 when the odor-filtering media is spent. In the same or a different implementation, the sidewalls of the containment vessel 420, 422 are substantially flexible and a control mechanism, such as a ratchet or wrench, is used to forcibly separate opposing walls by a distance, such as a few inches, to assist in the extraction of the spent odor-filtering media.

In one implementation where iron sponge media is the odor-filtering media, the iron sponge is maintained in a moist state in the containment vessel 420 or 422 under alkaline conditions to facilitate a reaction of H₂S with iron hydroxide in the iron sponge. As illustrated in the following equation, liquid water assists in a reaction between the H₂S and iron oxide (Fe₂O₃), yielding an insoluble pyrite-type composition (commonly called troilite) and removing the H₂S from the gas:

3H₂S+Fe₂O₃+H₂O→4H₂O+Fe₂S₃. (1)

Therefore, the odor filter system 400 may also have one or more fluid distribution components that provide for the transport and distribution of liquid throughout the filter layer (not shown).

In the implementation of FIG. 4, fluid spray piping 430, 431 enters each of the containment vessels 420, 422 through a sidewall or lid of the containment vessels 420 and 422, and the fluid is distributed into the odor-filtering media by a spray-bar (not shown) having a plurality of perforated holes. The spray bar runs across each of the containment vessels 420, 422 above the odor-filtering media therein. In one implementation, the fluid spray piping 430, 431 comprises a one-inch diameter pipe.

In other implementations, the fluid spray piping includes multiple spray bars that may have a plurality of nozzles, holes, fittings, etc. for distributing the liquid from the spray bars onto the odor-filtering media. In one exemplary implementation, the spray bar is constructed of PVC piping, although other types of tubing, such as stainless steel, are contemplated.

It may be appreciated that in alternate implementations, liquids other than water are distributed by the fluid distribution system (e.g., fluid spray piping 430 or 431). For example, the liquid may be an aqueous solution with various compounds, nutrients, biological agents, buffers, etc. For PH adjustment, sodium carbonate and/or sodium bicarbonate may be used, however, common caustic chemicals such as sodium, magnesium, calcium oxides or hydroxides may also be used.

Each of the containment vessels 420, 422 may also have one or more drainage pipes 428, 429 to permit excess fluids to exit the containment vessel. In one implementation, the drainage pipe (e.g., pipe 428) has a valve that can be manually opened. In another implementation, the drainage pipe 428 is a p-trap pipe that allows drainage to flow from the containment vessel but does not allow air in. In a preferred implementation, the drainage pipes 428, 429 are about two inches in diameter. In another implementation, the liquid draining from the drainage pipes is contained and redistributed by the fluid spray piping 430, 431.

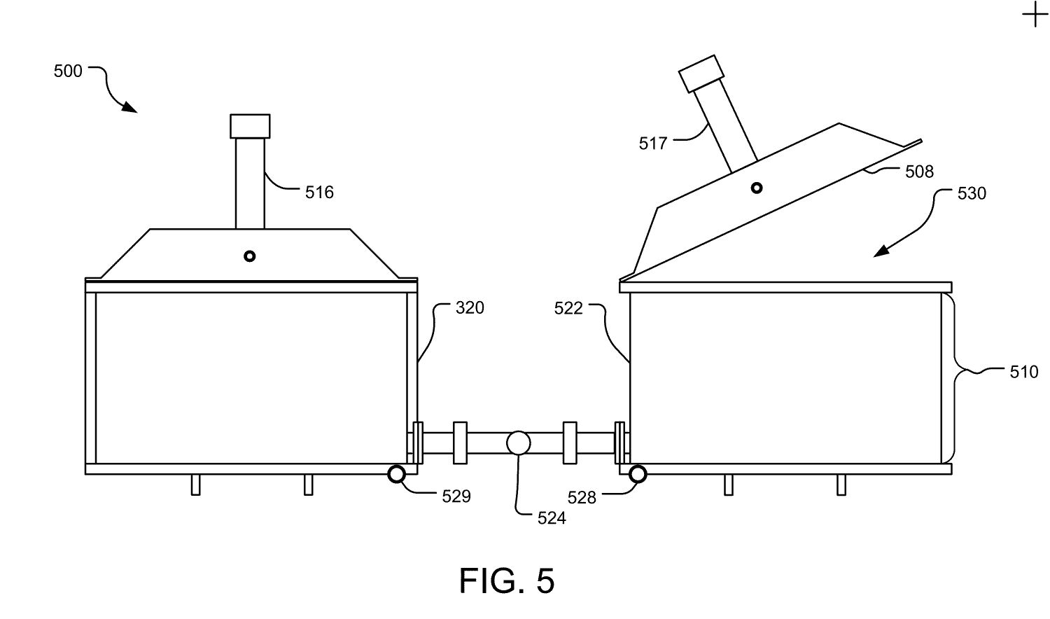

FIG. 5 illustrates a front perspective view of the example odorous gas filter system 500 in one implementation. The system comprises two separate containment vessels 520 and 522 sharing a single byproduct gas inlet 524. Each containment vessel has a media inlet opening 530 formed between a lid (e.g., lid 508) and a base portion (e.g., base portion 510) of the containment vessel 520, 522. In one implementation, the containment vessel lid 508 is hingedly attached to a sidewall of base portion 510 of the containment vessel 520, 522. The media inlet openings (e.g., opening 530) may be used for loading odor-filtering media into the containment vessels 520 or 522 and/or for positioning nets or geotextile material within the containment vessels 520 or 522 prior to the insertion of odor-filtering media. The nets and/or geotextile material may be used to shape, support, and/or to assist in the extraction of the odor-filtering media.

The system also includes one or more byproduct gas inlets 524 and one or more vent pipes 516 and 517 to allow filtered gas to exit the containment vessels 520 and 522. Fluid spray piping (not shown) may transport and distribute liquid throughout the odor-filtering media in the containment vessels 520, 522. Excess liquid may drain from the containment vessels 520, 522 via drainage pipes 529, 528 respectively.

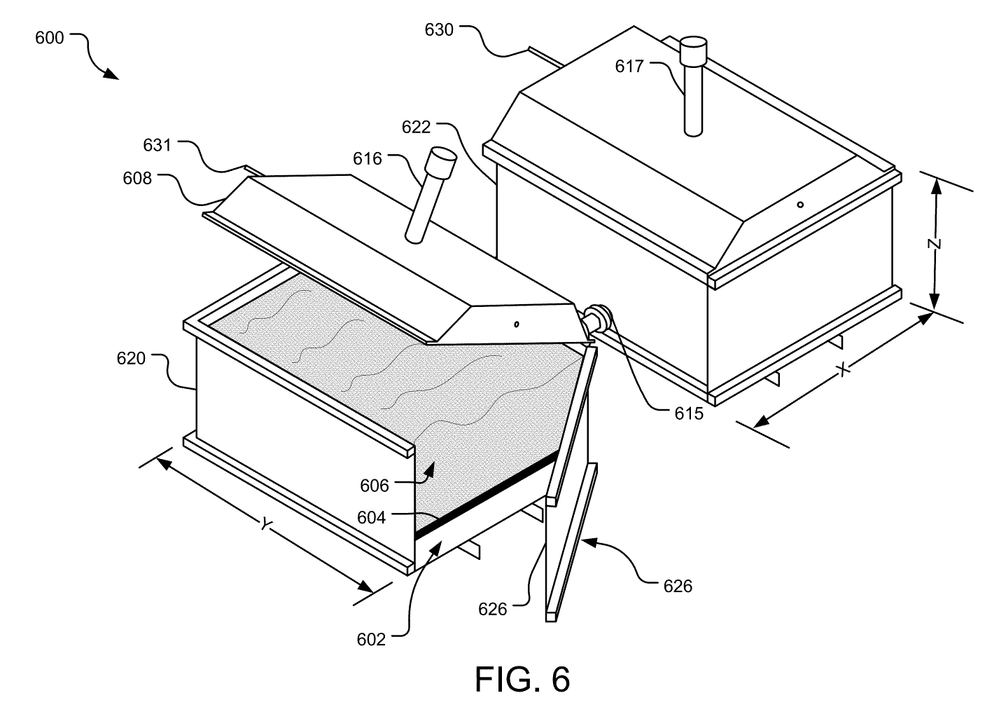

FIG. 6 illustrates an isometric perspective view of an example odorous gas filter system 600 in one implementation. The system comprises two separate containment vessels 620 and 622 sharing a single byproduct gas inlet (not shown). Byproduct gas enters into each containment vessel through a containment vessel inlet (e.g., inlet 615), which may be near the base of each of the containment vessels 620 and 622. The byproduct gas is directed into a gas plenum layer 602, through a diffuser plate 604, and into a filter layer 606, wherein odorous, sulfur-bearing compounds in the byproduct gas react with an odor-filtering media.

The containment vessels 620 and 622 each have a lid (e.g., the lid 608) hingedly attached to one or more sidewalls of the containment vessels 620 and 622. Opening the lid may facilitate the loading of the odor-filtering media into the containment vessel 620 and 622. The containment vessels 620 and 622 also have a side door (e.g., the side door 626) hingedly attached to one or more sidewalls of the containment vessels 620 and 622. Opening the sidedoor may facilitate extraction of spent odor-filtering media from the containment vessel.

Fluid spray piping 630, 631 enters each of the containment vessels 622, 620 through a sidewall or a lid (e.g. the lid 608). The fluid is distributed into the odor-filtering media by one or more pipes running across the containment vessels 620 and 622 above the odor-filtering media in media layer 602. Each of the containment vessels 620 and 622 may also have one or more drainage pipes (not shown) to permit excess fluids to drain from the containment vessels 620 and 622.

Specific dimensions of the containment vessels 620 and 622 and of the layers therein (e.g., the gas plenum layer 602, the diffuser plate 604, and the media layer 606) may differ according to desired design criteria. However, in one implementation, the containment vessel is approximately 103.25 inches across (shown by distance X) 124 inches deep (shown by distance Y), and 60 inches high (shown by distance Z).

The total weight of the odor containment vessel including the odor-filtering media may vary; however, in one implementation it is less than or equal to 23,500 pounds. In this implementation the containment vessel 620 or 622 supports a byproduct gas flow rate of 800 cubic feet per minute having an average of 130 parts per million of H₂S, and the filter layer 606 in the containment vessel holds 252 cubic feet of odor-filtering media when the system is in use.

In one implementation, certain components of the system may be removed prior to transportation of the containment vessel 620 or 622 in order to reduce the total weight of the containment vessel 620 or 622 below the weight limit imposed on commercial vehicles (e.g., 24,000 lb). For example, the lid 608 of the containment vessel might be removed before the containment vessel is loaded onto a truck and transported to a new location.

In cold climates, it may be desirable to control the temperature of the odor-filtering media so as to ensure that the odor-filtering media reacts with the odorous gases in the byproduct gas. Therefore, in one implementation there exists a heat exchanger above or preferably below the distribution plate 604 that may be used to warm the odor-filtering media to a temperature conducive to the targeted chemical reaction.

The odor-filtering media within the filter layer 606 has a set lifetime that depends upon the reaction rate of the odor-filtering media with the odorous compounds in the byproduct gas. However, certain secondary reactions, discussed below, may work to extend the effective lifetime of the odor-filtering media, reducing labor and material costs associated with replacing the odor-filtering media.

For instance, the lifetime of iron sponge media can be extended by adding of small amounts of air to the system, which facilitates the partial conversion of the iron sulfide species back into iron hydroxides/oxides and a sulfate, elemental sulfur and/or bisulfides. In one implementation, this occurs according to Equation (2) below:

2Fe₂S₃+3O₂→2Fe₂O₃+6S. (2)

Accordingly, the addition of air to iron sponge media contained in the filter layer 606 may result in doubling the operating life of iron sponge media. To achieve this result, one or more vents (such as byproduct gas vent pipes 616, 617) in the containment vessel 620, 622 permits the free-flow of air into the system.

In another implementation, an oxidizing chemical is applied to the odor-filtering media within the filter layer 606 to extend the operating life of the odor-filtering media. Oxidizing chemicals that may be used include, without limitation, calcium hypochlorite, sodium hypoclorite, hydrogen peroxide, ozone, oxygen, chlorine gas, perchlorate compounds, and permanganate compounds. Any one or combination of such oxidizing chemicals may be applied to spent or partially spent odor-filtering media to oxidize troilite in the spent media, producing iron hydroxide and a sulfur species such as elemental sulfur, sulfur dioxide, sulfur trioxide, and/or sulfate. The oxidizing chemical may react under anaerobic, aerobic, or facultative processes.

In one example implementation, the oxidizing chemical is calcium hypochlorite in a liquid state that is added to iron sponge media to facilitate the regeneration of iron oxide and iron hydroxide from the spent odor-filtering media.

Further, some strong oxidizing chemicals such as sodium hypochlorite and hydrogen peroxide have been shown to reduce or eliminate insoluble byproducts (including calcium sulfate) that may be created in such regeneration processes. For example, calcium sulfate that is normally produced in a reaction between spent iron sponge media and calcium hypochlorite may not be created in the presence of sodium hypochlorite. Finally, the addition of one or more oxidizing chemicals described above may also result in a partial softening of the spent odor-filtering media material, thus facilitating the removal of the spent odor-filtering media from the containment vessel 620 or 622.

The regeneration of iron-oxide from spent odor-filtering media can also be accelerated by select bacterial types, fungi, and biological nutrients. For instance, the class of bacteria known as acidophiles can be utilized as a causative agent for the conversion of iron sulfide compounds into iron oxides and sulfur species such as bisulfides, sulfates, and elemental sulfur. Specifically, the bacteria Acidithiobacillus ferrooxidans aka Thiobacillus ferrooxidans (referred to hereinafter as “acidophile bacteria”), utilizes the conversion of Fe(II) into Fe(III) as an energy source. Therefore, acidophile bacteria may be used in conjunction with certain other ferrooxidans, thiooxidans, sulfidooxidans and oxides to break down triolite absorbed onto spent or partially spent odor-filtering media (i.e., the iron sulfide compound), forming sulfate and elemental sulfur. For example, acidophile bacteria may be added to iron sponge media to react with triolite formed by a reaction between iron sponge and H₂S in the byproduct gas. This process leads to the regeneration of iron hydroxide and/or iron oxides, extending the effective life of the iron sponge or other iron based odor-filtering media. Documented reports show the presence of these type of bacteria can increase the rate of pyrite oxidation by up to 106 as compared to the rate at which pyrite is oxidized in the presence of air without such bacteria.

In addition to acidophile bacteria, other bacteria may aid the conversion of pyrite-type compounds to the oxidized form of the Fe(III) and sulfur species such as sulfates, elemental sulfur, and bisulfides. These bacteria may, for example, be in the families Leptospirillum ferrooxidans, Acidithiobacillus thiooxidans, and sulfobacillus thermosulfidooxidans.

Additionally, the presence of certain fungal strains may also facilitate the regeneration of the iron hydroxide/oxides and thus extend the operating life of the odor-filtering media, especially when in the presence of the above-cited bacteria. For example, the breakdown of the odor-filtering media by the fungal strains may expose a number of new reactive functional sites for the removal of siloxanes and silanols present in the byproduct gas. Such removal occurs through an interaction between the siloxanes and/or silanols and a functional group (i.e., the functional group —CH₂OH) in repeating glucosic molecules in the wood chips. The fungal strains capable of breaking down the odor-filtering media to expose these new functional sites may include, for example, fungal strains common in compost piles including wood and cellulosic products.

In one implementation, the odor-filtering media contains wood chips and acidophile bacteria. Fungi added to the media work to anaerobically digest the wood chips, providing for regeneration of iron hydroxides and iron oxides and for new functional sites for the removal of siloxanes and solanols. Here, the odor-filtering media operationally provides for the simultaneous removal of sulfide-containing materials and siloxane/silanol materials from the byproduct gas.

The above-discussed strains of bacteria and fungi (collectively hereinafter the “biological additives”) may be added to the odor-filtering media in a variety of ways. In one implementation, the biological additives are sprinkled onto the odor-filtering media during loading. In one implementation, approximately one teaspoon of biological additives are sprinkled onto the odor-filtering media before the lid 608 is secured. In an alternate implementation, the biological additives are placed in the gas plenum layer 602 below the diffuser plate 604.

In another implementation, nutrients are added to the odor filter system 600 to feed the odor-filtering media. A minor amount, such as a teaspoon, of nutrients are added to the odor-filtering media every two to four weeks. The nutrients may include, for example, nutrients common in lawn fertilizers such as iron, nitrogen, phosphorus, sulfur, etc.

The nutrients may be added to the odor filter system 600 in a variety of ways. In one implementation, the nutrients are added by use of a spray applied to the odor-filtering media prior to loading or after loading into the containment vessel 620 or 622. In another implementation, nutrients are added to the odor-filtering media after it is loaded into the filter layer (e.g., by way of a hand-held spray, the fluid spray piping 630, or other fluid distribution system). In an alternate implementation, nutrients are mixed into the odor-filtering media before it is placed in the filter layer 606.

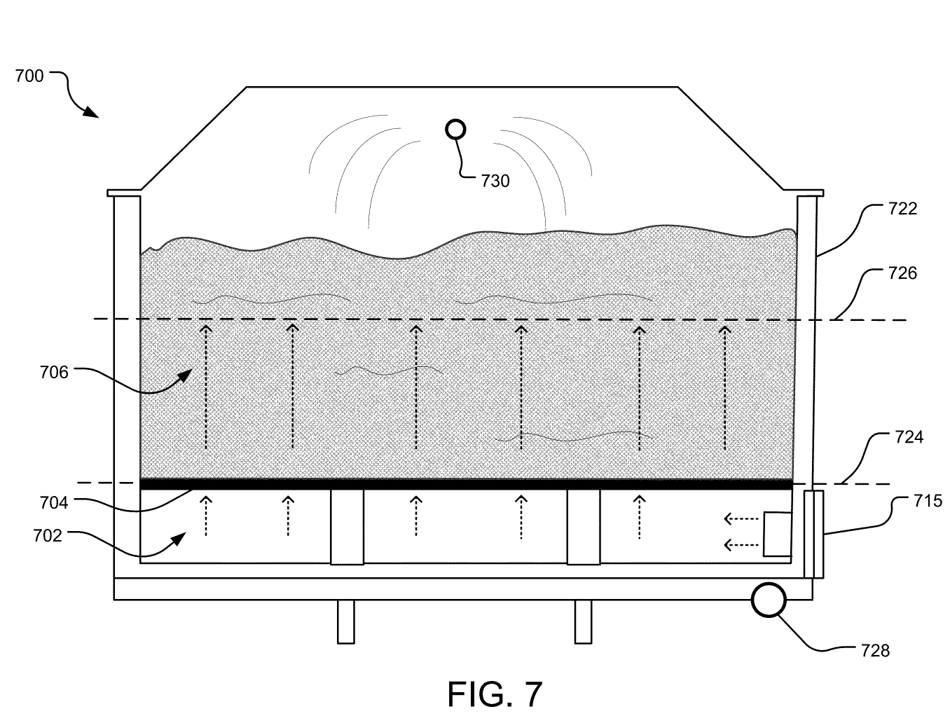

FIG. 7 is a cross-sectional view of an example odorous gas filter system 700 in one implementation. The system includes a containment vessel 722 having a gas plenum layer 702, a diffuser plate 704, and a filter layer 706 containing an odor-filtering media. The gas plenum layer 702 illustrated is an gas cavity at the base of the containment vessel 722.

Dotted arrows in FIG. 7 illustrate the path of byproduct gas throughout the odor-filtering media in the containment vessel 722. In operation, byproduct gas is directed into the gas plenum layer 702 of the containment vessel through an input valve 715. A gradual pressure builds below the diffuser plate 704, causing the byproduct gas to spread out across the surface of the plate 704 before passing through it. A uniform distribution of the byproduct gas is achieved throughout the vessel 722 along the uniform distribution line 724 as the byproduct gas passes through the diffuser plate 704. Once through the diffuser plate 704, the byproduct gas moves throughout the filter layer 706 and odorous gases in the byproduct gas react with the odor-filtering media stored in the filter layer 706. The uniform distribution of the byproduct gas remains substantially constant as the byproduct gas moves between uniform distribution line 724 and the top of the vessel 722. Thus, a substantially even distribution of byproduct gas exists at a height 726.

In one implementation, the odor-filtering media is iron sponge. Hydrogen sulfide in the byproduct gas reacts with the iron sponge, forming pyrite or a pyrite-type compound, such as troilite. A liquid distribution system 730 distributes a liquid, such as water or water enriched with nutrients, biological agents, buffers, etc., into the odor-filtering media. This liquid may serve to assist in a reaction between the H₂S and iron hydroxide in the iron sponge and/or feed biological agents present in the odor-filtering media.

In one implementation, the water distribution system distributes five to ten gallons of water for a few minutes once daily, but the amount of water utilized may depend on specific design criteria and local climate conditions. Excess liquid may drip through the odor-filtering media and distribution plate 704 and be drained from the containment vessel from a drainage valve 728.

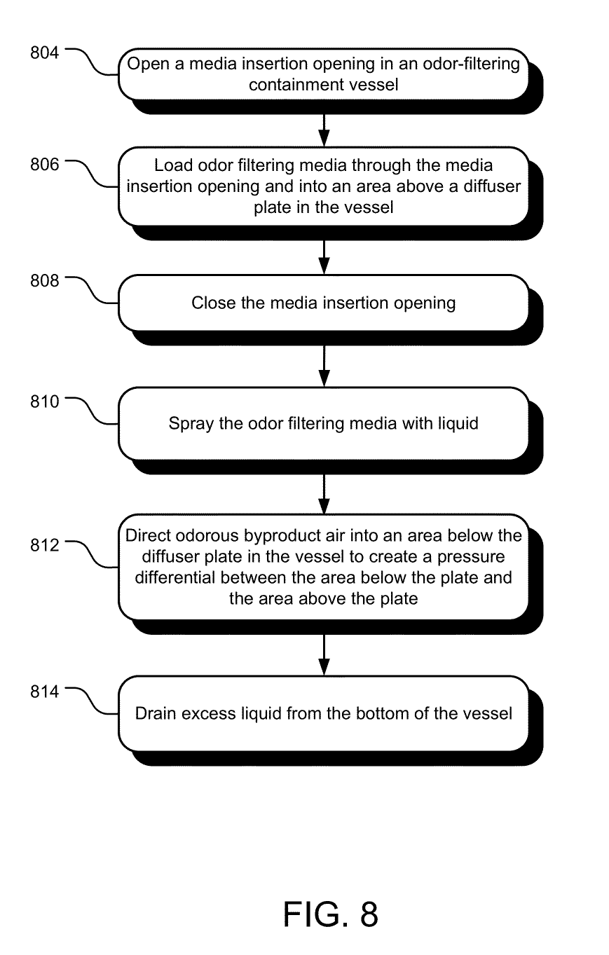

FIG. 8 illustrates example operations for an odor filter system 800 according to one implementation. An opening operation 804 opens a lid or door in an odor-filter containment vessel to facilitate a loading operation 806. In the loading operation 806, an odor-filtering media is loaded through the opening and into an area above a diffuser plate inside the containment vessel. After the odor-filtering media is loaded into the containment vessel, a closing operation 808 closes the lid or door, blocking the opening and a watering operation 810 sprays the odor-filtering media.

A filtering operation 812 directs or pumps odorous byproduct gas into an area below the diffuser plate in the odor filter containment vessel. As more gas flows into the containment vessel, an engineered pressure drop is created between the area below the plate containing the byproduct gas and the area above the plate containing the moistened odor-filtering media. The byproduct gas evenly distributes itself throughout the area below the diffuser plate, passes through the diffuser plate, and reacts with the odor-filtering media. Filtered gas exits the containment vessel through one or more vents near the top of the containment vessel. At drainage operation 614, excess water is drained from the containment vessel.

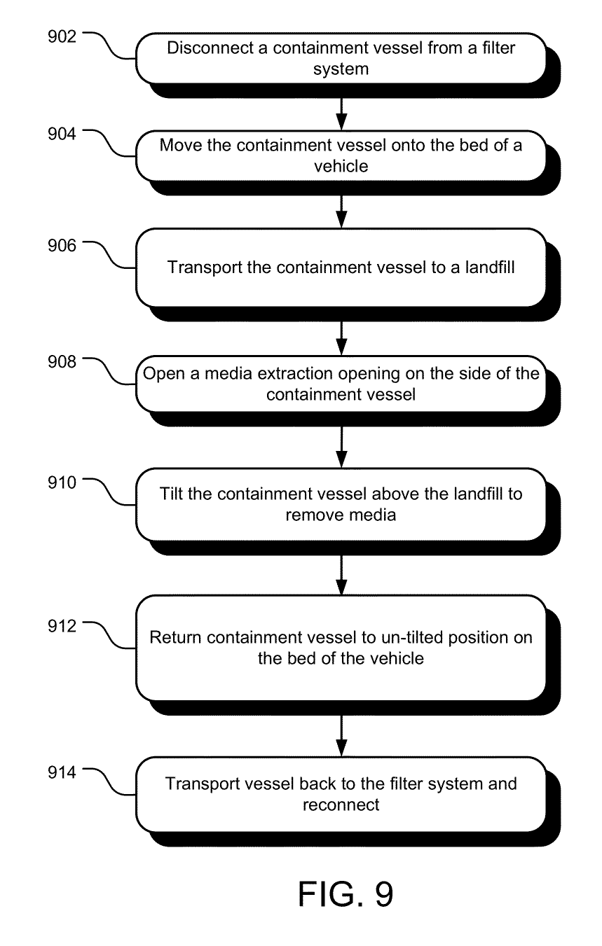

FIG. 9 illustrates example operations for disposing of odor-filtering media in an odor filter system 900 according to one implementation. A disconnecting operation 902 disconnects a containment vessel from one or more components of an odor filter system. Disconnecting the containment vessel may entail closing one or more byproduct gas valves that direct gas into the containment vessel, disconnecting one or more byproduct gas lines connected to the valves, and/or disconnecting one or more water lines from the containment vessel.

A moving operation 904 then moves the containment vessel onto a bed of a truck or other vehicle. In one implementation, the containment vessel is secured to the back of a dump truck via one or more attachment mechanisms, such as cables and hooks. Once the containment vessel is secured onto the truck or other motor vehicle, a transportation operation 906 transports the containment vessel to a landfill or other waste disposal site. At the waste disposal site, an opening operation 908 opens a side door on the containment vessel before a tilting operation 910 tilts the containment vessel to one side, toward the open side door. For example, the bed of the dump truck may lift up at an angle while the containment vessel is still attached so that the containment vessel sits at an angle adjacent to a waste disposal area. When the containment vessel is tilted, an odor-filtering media within the containment vessel may fall out of the containment vessel or be manually shoveled out. A returning operation 912 returns the containment vessel to its original, non-tilted position on the vehicle and the containment vessel is transported back to its original location. At the original location, the containment vessel is re-connected to the filter system and a new load of odor-filtering media is loaded into the containment vessel.

The above specification, examples, and drawings provide a complete description of the structure and use of exemplary implementations of the invention. Since many implementations of the invention can be made without departing from the spirit and scope of the invention, the invention resides in the claims hereinafter appended. Furthermore, structural features of the different implementations may be combined in yet another implementation without departing from the recited claims.

What is claimed is:

1. A system comprising:
a containment vessel; and
a supporting diffuser assembly configured to support a gas phase chemical filtering media above a gas plenum layer in the containment vessel, wherein the supporting diffuser assembly has a plurality of holes that provide for an engineered pressure drop between a lower surface of the supporting diffuser assembly and an upper surface of the supporting diffuser assembly.

2. The system of claim 1, wherein the containment vessel is portable.

3. The system of claim 1, wherein the supporting diffuser assembly provides for even gas distribution across a surface of the supporting diffuser assembly before the gas passes through the supporting diffuser assembly.

4. The system of claim 1, wherein the supporting diffuser assembly includes a rigid diffuser plate.

5. The system of claim 4, further comprising:
a gas plenum layer below a surface of the supporting diffuser assembly; and
a gas phase chemical filtering media above a surface of the supporting diffuser assembly.

6. The system of claim 4, wherein the gas phase chemical filtering media further comprises select biological agents including acidophile bacteria.

7. The system of claim 6, wherein the gas phase chemical filtering media includes nutrients to feed the acidophile bacteria.

8. The system of claim 1, further comprising a media loading opening for loading a gas phase chemical filtering media into the containment vessel and a media extraction opening for removing the gas phase chemical filtering media from the vessel.

9. The system of claim 1, wherein byproduct gas is directed into the containment filter vessel below a side of the diffuser plate assembly and the byproduct gas flows upward through the containment vessel.

10. The system of claim 1, wherein the gas phase chemical filtering media includes iron hydroxide impregnated in a wood substrate.

11. A method comprising:
constructing a containment vessel having a supporting diffuser assembly positioned therein, wherein the supporting diffuser assembly is configured to support a gas phase chemical filtering media above a gas plenum layer, and wherein the supporting diffuser assembly has a plurality of holes that provide for an engineered pressure drop between a lower surface of the supporting diffuser assembly and an upper surface of the supporting diffuser assembly.

12. The method of claim 11, wherein the supporting diffuser assembly includes a rigid diffuser plate.

13. The method of claim 11, wherein the gas phase chemical filtering media includes iron hydroxide impregnated in a wood substrate.

14. The method of claim 11, wherein the gas phase chemical filtering media includes activated carbon.

15. The method of claim 11, wherein the gas phase chemical filtering media filters out select components from a byproduct gas.

16. The method of claim 11, wherein the containment vessel has a media loading opening for loading the gas phase chemical filtering media into the vessel and a media extraction opening for removing the gas phase chemical filtering media from the vessel.

17. The method of claim 11, wherein the gas phase chemical filtering media includes biological agents including acidophile bacteria to extend the operating life of the gas phase chemical filtering media.

18. The method of claim 11, further comprising:
connecting at least one water line to the containment vessel to distribute a liquid onto the gas phase chemical filtering media within the containment vessel.

19. A method comprising:
loading a gas phase chemical filtering media onto a supporting diffuser assembly positioned in a containment vessel, wherein the supporting diffuser assembly is configured to support the gas phase chemical filtering media above a gas plenum layer, and wherein the supporting diffuser assembly has a plurality of holes that provide for an engineered pressure drop between a lower surface of the supporting diffuser assembly and an upper surface of the supporting diffuser assembly; and
inputting byproduct gas into the gas plenum layer.

20. The method of claim 19, wherein the supporting diffuser assembly includes a rigid diffuser plate.

21. The method of claim 19, further comprising:
filtering the byproduct gas through the gas phase chemical filtering media; and
releasing the filtered byproduct gas from the containment vessel by passing it through at least one vent.

22. The method of claim 19, wherein filtering the byproduct gas filters out select components of the byproduct gas,

23. The method of claim 19, further comprising:
spraying the gas phase chemical filtering media with a liquid; and
draining the liquid from the vessel.

24. The method of claim 19, wherein the gas phase chemical filtering media includes iron hydroxide impregnated in a wood substrate.

25. The method of claim 19, wherein the gas phase chemical filtering media includes iron hydroxide and acidophile bacteria.

26. The method of claim 19, further comprising:
transporting the containment vessel to a site for disposal of the gas phase chemical filtering media;
opening a media extraction door;
tipping the containment vessel to a side to facilitate removal of the gas phase chemical filtering media through the media extraction door.

27. The method of claim 26, further comprising:
adding nutrients to the gas phase chemical filtering media to feed the acidophile bacteria.
